(19) United States
(12) Patent Application Publication
(10) Pub. No.: US 2015/0065041 A1
(43) Pub. Date: Mar. 5, 2015

(54) PORTABLE DEVICE USING A COMMON ANTENNA FOR BOTH NEAR FIELD COMMUNICATION AND WIRELESS CHARGING

(71) Applicant: MAXWAVE CO., LTD, Daejeon (KR)

(72) Inventor: Dong Sik Ahn, Daejeon (KR)

(73) Assignee: MAXWAVE Co., Ltd., Daejeon (KR)

(21) Appl. No.: 14/389,347

(22) PCT Filed: Apr. 2, 2013
(86) PCT No.: PCT/KR2013/002711

§ 371 Date: Sep. 29, 2014

(30) Foreign Application Priority Data
Apr. 3, 2012 (KR) 10-2012-0034495

(51) Int. Cl. H04B 5/00; H02J 7/02

(52) U.S. Cl. CPC H04B 5/0037; H02J 7/025; H02J 2007/0096
USPC 455/41.1

(57) ABSTRACT

Provided is a portable device using a common antenna for both near field communication and wireless charging. The portable device includes: a common antenna part transmitting and receiving near field communication and wireless charging signals; an NFC signal judgment module connected to the common antenna part and sensing a signal applied from the common antenna part or a Tx signal generated from an NFC performing part to thereby judge whether or not the signal applied from the common antenna part or the Tx signal is the near field communication signal; an NFC performing part connected to the NFC signal judgment module and performing near field communication according to a control signal transferred from the NFC signal judgment module; and a battery part connected to the NFC signal judgment module and being wirelessly charged according to the control signal transferred from the NFC signal judgment module.

### TECHNICAL FIELD

The present invention relates to a portable device using a common antenna for both near field communication (NFC) and wireless charging, and more particularly, to a portable device using a common antenna enabling the portable device to be miniaturized and lightened by using the common antenna capable of implementing both near field communication and wireless charging.

### BACKGROUND ART

In general, a portable device requires a dedicated battery charger and a dedicated adaptor which converts alternating current power into direct current power. Therefore, whenever a user purchases the portable devices, the user should purchase the dedicated battery charger and the dedicated adaptor, and as a result, the number of dedicated battery chargers and dedicated adaptors has gradually been increased and a plurality of dedicated battery chargers need to be connected to a power supply to charge the portable device, which make it even more inconvenient.

In order to solve the above-mentioned problems, a method of charging the portable device with power in a non-contact method, that is, a wireless charging method has been recently developed. The wireless charging method is generally classified into two methods, and one is a magnetic induction method and the other is a magnetic resonance method. The magnetic induction method is a method in which if a current flows into a primary coil of a magnetic field radiating coil pad and a magnetic field is generated accordingly, an induced current flows in a secondary coil of a receiver placed immediately on the magnetic field radiating coil pad to thereby charge the portable device. Subsequently, wireless charging is possible at distances of about several mm to several cm. In addition, the magnetic resonance method is a method in which a transmitter and a receiver for wireless charging are equipped with a resonance coil, such that when resonance frequencies of the transmitter and receiver are matched, energy is transmitted to the portable device, and when the resonance frequencies are not matched, the energy is absorbed into an electrical and magnetic field, and by using the magnetic resonance method, the charging up to several meters away is possible.

However, in order to use the wireless charging method for the portable device as described above, a separate antenna for wireless power transmission is required, and in addition to this, various antennas such as a Bluetooth antenna, a Wi-Fi antenna, a Long Term Evolution (LTE) antenna, a Digital Multimedia Broadcasting (DMB) antenna, an amplitude modulation (AM)/frequency modulation (FM) antenna, an antenna for NFC communication, and the like are required of the portable antenna.

Korean Patent No. 10-0971717 entitled “Wireless Type Charging and Data Communication Control Module for Mobile Terminal and Layout of the Same” (hereinafter, referred to as the related art 1), has disclosed a structure in which both a power receiving coil of a charging system and a loop antenna of an electronic approval system are mounted in a battery pack and a cover case of a mobile terminal, such that both a non-contact charging and an electronic approval are possible using one mobile terminal.

However, in accordance with the related art 1, since both the power receiving coil for the non-contact charging and the loop antenna for the electronic approval system are mounted in one mobile terminal, a thickness of the mobile terminal itself becomes thick and an area of the mobile terminal is increased, there is a problem that it is inconvenient to carry the mobile terminal despite being the mobile terminal.

### DISCLOSURE

### Technical Problem

An object of the present invention is to provide a portable device which is miniaturized, thinned, and lightened by using a common antenna capable of performing both near field communication and wireless charging to thereby reduce the number of antennas mounted in the portable device.

### Technical Solution

In one general aspect, a portable device using a common antenna for both near field communication (NFC) and wireless charging includes: a common antenna part 10 transmitting and receiving near field communication and wireless charging signals; an NFC signal judgment module 100 connected to the common antenna part 10 and sensing a signal applied from the common antenna part 10 or a Tx signal generated from an NFC performing part 200 to thereby judge whether or not the signal or the Tx signal is the near field communication signal; an NFC performing part 200 connected to the NFC signal judgment module 100 and performing the near field communication according to a signal transferred from the NFC signal judgment module 100; and a battery part 300 connected to the NFC signal judgment module 100 and being wirelessly charged according to the control signal transferred from the NFC signal judgment module 100.

The NFC signal judgment module 100 may include: a signal matching part 110 converting antenna impedance transferred through the common antenna part 10 into impedance which is suitable for both near field communication and wireless charging and transferring the near field communication signal to the NFC performing part 200 or a signal controlling part 130; a signal converting part 120 including a RF/DC converter 121 converting the wireless signal transferred from the signal matching part 110 into a direct current voltage and a regulator 122 uniformly supplying the direct current voltage converted by the RF/DC converter 121; a signal controlling part 130 judging whether or not the wireless signal is the near field communication signal; a first switch 400 controlling an operation of the NFC performing part 200 depending on a signal of the signal controlling part 130; and a second switch 500 controlling an operation of the battery part 300 depending on the signal of the signal controlling part 130.

The signal matching part 110 may include: an NFC signal matcher 111 converting the antenna impedance transferred from the common antenna part 10 into the impedance which is suitable for the near field communication and transferring the near field communication signal to the NFC performing part 200; a wireless charging signal matcher 112 converting the antenna impedance transferred from the common antenna part 10 into the impedance which is suitable for the wireless charging; and a selection switch 113 transferring the near field communication signal transferred from the NFC signal matcher 111 or the wireless charging signal transferred from the wireless charging signal matcher 112 to the signal converting part 120.

The selection switch 113 may re-transfer the signal to the NFC signal matcher 111 depending on the signal transferred from the signal controlling part 130.

The regulator 122 may uniformly supply the direct current voltage transferred from the RF/DC converter 121 to the signal controlling part 130 or the second switch 500.

The signal controlling part 130 may include: a signal demodulator 131 demodulating the wireless signal transferred from the signal matching part 110 to obtain digital information; an identification (ID) storage part 132 storing unique ID for near field communication; and a signal judgment device 133 comparing the demodulated signal transferred from the signal demodulator 131 with the unique ID stored in the ID storage part 132 or sensing the Tx signal by the near field communication transferred from the NFC performing part 200 to thereby judge whether or not the demodulated signal or the Tx signal is the near field communication signal.

### Advantageous Effects

According to the present invention, the number of antennas used for the portable device may be reduced by performing the near field communication or the wireless charging by the common antenna, thereby simplifying a process of manufacturing the antenna.

In addition, since an area of a circuit in the portable device may be reduced by using a unified chip for both near field communication and wireless charging, production cost may be reduced.

### DESCRIPTION OF DRAWINGS

FIG. 1 is a diagram schematically illustrating a portable device using a common antenna for both near field communication and wireless charging according to an embodiment of the present invention.

FIG. 2 is a diagram schematically illustrating a portable device using a common antenna for both near field communication and wireless charging according to another embodiment of the present invention.

FIG. 3 is a diagram specifically illustrating the portable device using the common antenna for both near field communication and wireless charging according to the embodiment of the present invention.

FIG. 4 is a flow chart illustrating a method of controlling a signal which is input from a signal controlling part according to an embodiment of the present invention.

FIG. 5 is a flow chart illustrating a method of controlling a signal which is input from a signal controlling part according to another embodiment of the present invention.

### BEST MODE

Hereinafter, a portable device using a common antenna for both near field communication and wireless charging according to the present invention will be described in detail with reference to the accompanying drawings. The drawings of the present invention to be described below are provided by way of example so that the idea of the present invention can be sufficiently transferred to those skilled in the art to which the present invention pertains. Therefore, the present invention is not be limited to the drawings provided below but may be modified in many different forms. In addition, like reference numerals denote like elements throughout the specification.

In this case, technical terms and scientific terms used in the specification have the general meaning understood by those skilled in the art to which the present invention pertains unless otherwise defined, and a description for the known function and configuration obscuring the present invention will be omitted in the following description and the accompanying drawings.

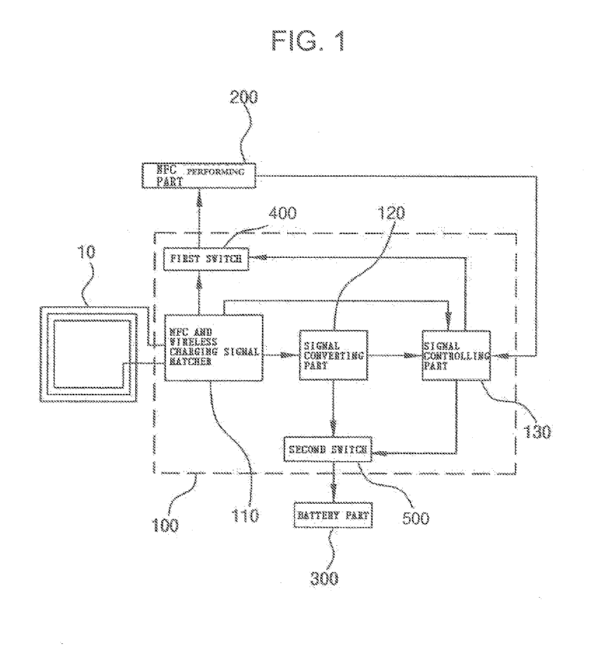

FIG. 1 is a diagram schematically illustrating a portable device using a common antenna for both near field communication and wireless charging according to an embodiment of the present invention.

A configuration of the portable device using the common antenna for both near field communication and wireless charging according to the embodiment of the present invention will be described in detail with reference to FIG. 1.

The portable device using the common antenna for both near field communication and wireless charging according to the embodiment of the present invention is configured to include a common antenna part 10, a near field communication (NFC) signal judgment module 100, an NFC performing part 200, and a battery part 300.

The near field communication (NFC) means a non-contact type communication technology transmitting and receiving various wireless data at a close distance, and has been widely utilized for goods information in a store, travel information for tourists, a locking apparatus for access control, and the like as well as an approval system. In addition, wireless charging according the related art means that the portable device mounted on a magnetic field radiating coil pad together with an electromotive circuit for a charger is charged through a wired charging connector without requiring a dedicated battery charger and dedicated adaptor for charging. However, according to the related art as described above, in order to perform both near field communication and wireless charging in the portable device, the respective separate antennas transmitting and receiving near field communication and wireless charging signals are required.

Therefore, the common antenna part 10 may simultaneously transmit and receive the near field communication (NFC) and wireless charging signals.

In general, the signals for both near field communication and wireless charging may use the same frequency, that is, 13.5 MHz. When the common antenna part 10 receives a wireless signal, the wireless signal may be transferred to the NFC signal judgment module 100.

The NFC signal judgment module 100 may be connected to the common antenna part 10 to thereby judge whether or not the wireless signal transferred from the common antenna part 10 is a signal for near field communication, or may sense a Tx signal generated by the near field communication which is already operated in the NFC performing part 200 to thereby judge whether or not the Tx signal is the signal for near field communication. Therefore, the NFC signal judgment module 100 transfers the signal to the NFC performing part 200 in the case in which the wireless signal or the Tx signal is the signal for near field communication, and transfers the signal to the batter part 300 in the case in which the wireless signal or the Tx signal is not the signal for near field communication, thereby making it possible to wirelessly charge a battery pack.

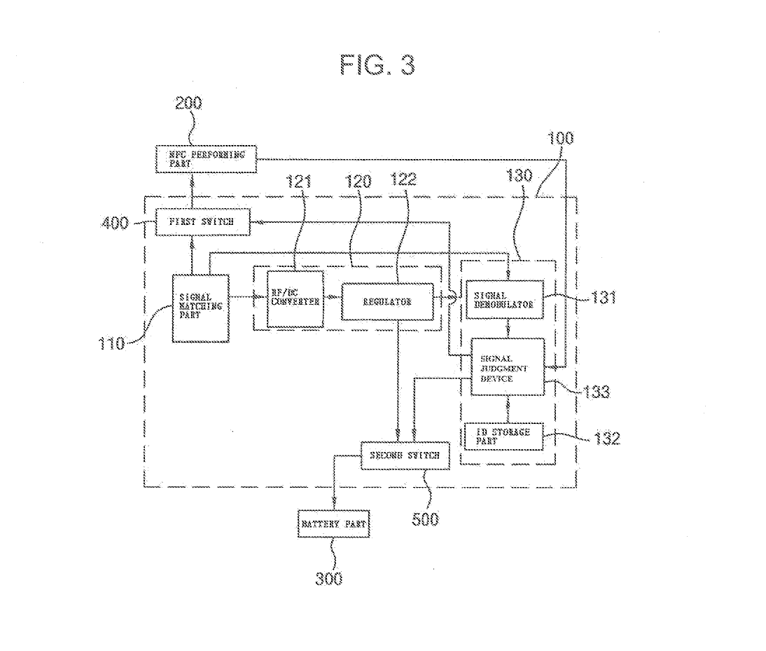

The NFC signal judgment module 100 may be configured to include a signal matching part 110, a signal converting part 120, a signal controlling part 130, a first switch 400, and a second switch 500, and the NFC signal judgment module 100 will be described in detail with reference to FIG. 3.

In this case, in order to activate the NFC performing part 200 for near field communication, the first switch 400 may be configured, and in order to activate the battery part 300 for wireless charging, the second switch 500 may be configured. Further, the first switch 400 and the second switch 500 are controlled depending on results judged by the signal controlling part 130, and a logic part (not shown) for controlling the first switch 400 and the second switch 500 may be configured in the signal controlling part 130.

The signal matching part 110 may be connected to the common antenna part 10 to thereby convert the signal transferred from the common antenna part 110, that is, antenna impedance into impedance which is suitable for both near field communication and wireless charging. In this case, a frequency of the signal transferred through the common antenna part 10 may be generally 13.5 MHz which is equal to that used for both near field communication and wireless charging.

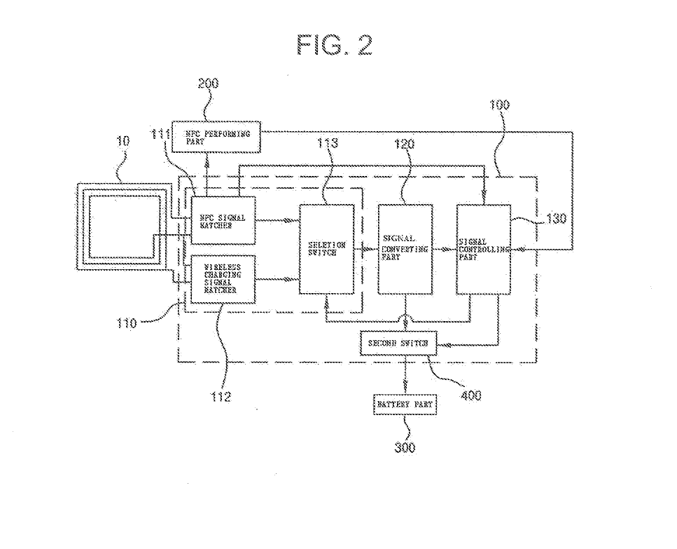

Meanwhile, even though a frequency for both near field communication and wireless charging is significantly changed, the signal matching part 110 is configured to further include an NFC signal matcher 111, a wireless charging signal matcher 112, and a selection switch 113, as shown in FIG. 2, such that the signals which are differently input to the common antenna part 10 for both near field communication and wireless charging may be converted into appropriate impedance. That is, the signal transferred from the common antenna part 10, that is, antenna impedance may be converted into impedance which is suitable for near field communication by the NFC signal matcher 111, and the antenna impedance may be converted into impedance which is suitable for wireless charging by the wireless charging signal matcher 112.

The selection switch 113 may select a near field communication signal transferred from the NFC signal matcher 111 and a wireless charging signal transferred from the wireless charging signal matcher 112 depending on the transferred signal to thereby transfer the selected signal to the signal converting part 120. Further, in the case in which the selection switch 113 receives the wireless signal which is judged as a near field wireless signal by the signal controlling part 130, it may maintain a connection with the NFC signal matcher 111 and block a connection with the wireless charging signal matcher 112.

The signal converting part 120 may be configured to include a RF/DC converter 121 and a regulator 122, wherein the RF/DC converter 121 may convert a radio frequency (RF) signal, which is a wireless signal, into a direct current voltage, and the regulator 122 may supply a voltage transferred from the RF/DC converter 121 to the signal controlling part 130 while uniformly maintaining the voltage. In addition, the regulator 122 may also stably supply a voltage which is suitable for wireless charging to the second switch 500 in order to activate the battery part 300 in the case in which the wireless charging needs to be performed, depending on the result judged by the signal controlling part 130.

Further, the portable device using the common antenna according to the present invention may include at least one RF/DC converter and regulator in order to use the RF/DC converter 121 and the regulator 122 for both near field communication and wireless charging, respectively, and may include the at least one RF/DC converter and regulator outside of the NFC signal judgment module 100, if necessary.

The signal controlling part 130 may sense the Tx signal which is generated and transferred by the near field communication which is already performed in the NFC performing part 200 by the wireless signal transferred from the signal matching part 110, or may judge the wireless signal transferred from the signal matching part 110 to the signal controller 130 to thereby judge whether or not the Tx signal or the wireless signal is the near field communication. The signal controlling part 130 may activate the NFC performing part 200 or the battery part 300 depending on the judged results. That is, in other words, depending on the judged results, the signal controlling part 130 may activate the NFC performing part 200 by transferring the signal to the first switch 400 in the case in which the Tx signal or the wireless signal is judged as the near field communication signal, and may activate the battery part 300 by transferring the signal to the second switch 500 in the case in which the Tx signal or the wireless signal is judged as the wireless charging signal.

Further, the signal controlling part 130 may be configured to include a signal demodulator 131, an ID storage part 132, and a signal judgment device 133, wherein

the signal demodulator 131 may use the direct current voltage applied by the RF/DC converter 121 in the signal converting part 120 as power, may demodulate the wireless signal transferred from the signal matching part 110, and may transfer the demodulated signal to the signal judgment device 133.

The ID storage part 132 may store unique ID for near field communication, and the signal judgment device 133 may compare the demodulated signal transferred from the signal demodulator 131 with ID information stored in the ID storage part 132 to thereby judge whether or not the transferred demodulated signal is the signal for near field communication.

Alternatively, in the case in which the Tx signal, which is transferred through the NFC performing part 200, that is, generated by the near field communication which is already performed, is transferred, the signal judgment device 133 may sense the transferred Tx signal to thereby judge whether or not the transferred Tx signal is the signal for near field communication.

To this end, the signal judgment device 133 may judge whether the demodulated signal transferred from the signal demodulator 131 is not the Tx signal, which is generated and transferred by the near field communication of the NFC performing part 200 but the signal for near field communication.

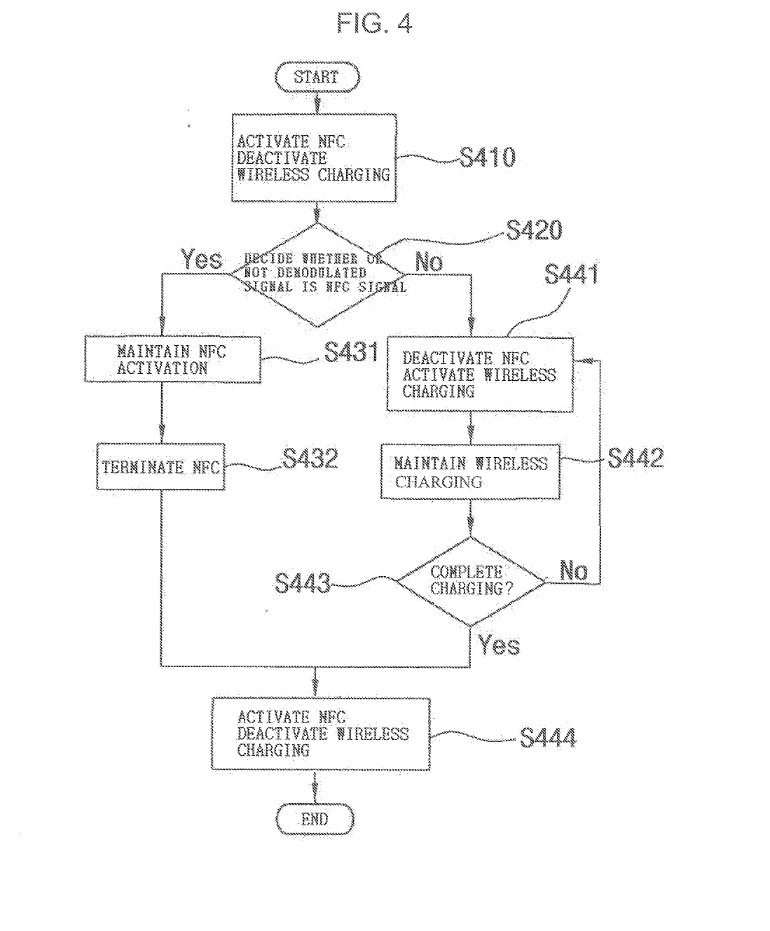

As shown in FIG. 4,

in the case in which the signal judgment device 133 receives the demodulated signal, it activates the NFC performing part 200 by first transferring the signal to the first switch 400 before performing judgment of the demodulated signal, and deactivates the battery part 300 for wireless charging by not transferring a separate signal to the second switch 500 (S410).

Next, it is judged whether or not the demodulated signal transferred from the signal judgment device 133 is the signal for near field communication (S420).

In the case in which the demodulated signal is the signal for near field communication depending on the judged result, the near field communication is maintained by maintaining an active mode of the NFC performing part 200 (S431), and as the near field communication is terminated, an operation of the NFC performing part 200 is terminated (S432).

On the other hand, in the case in which the demodulated signal is not the signal for near field communication depending on the result judged by the signal judgment device 133, that is, in the case in which the demodulated signal is the signal for wireless charging, the NFC performing part 200 is deactivated and the battery part 300 is activated by transferring the signal to the second switch 500 to thereby start the wireless charging (S441).

After the wireless charging is maintained for a predetermined time (S442), it is judged whether a charging of the portable device is completed (S443). Depending on the judged results, in the case in which the charging is completed, the NFC performing part 200 is activated by again transferring the signal to the first switch 400 and an operation of the battery part 300 is terminated (S444).

Alternatively, in another embodiment in which the signal judgment device 133 judges whether the demodulated signal transferred from the signal demodulator 131 is the signal for near field communication,

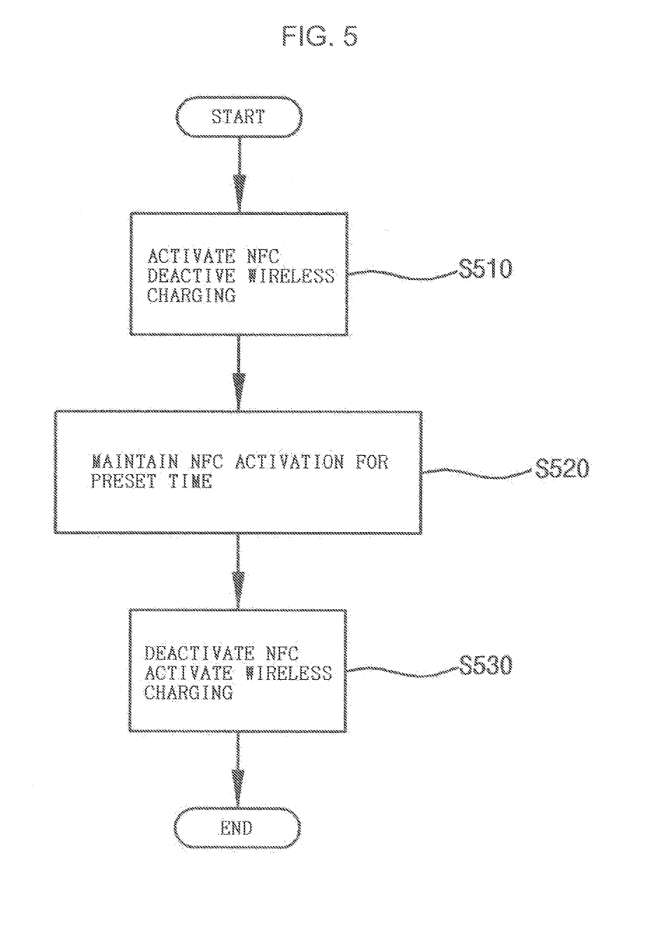

as shown in FIG. 5,

once the signal is transferred to the signal judgment device 133, the NFC performing part 200 is activated by preferentially transferring the signal to the first switch (S510), and

an activated mode of the NFC performing part 200 is maintained for a preset time (S520). In this case, the preset time according to the present invention may be one second and is a set time judged to be sufficient to perform the near field communication, which is merely one embodiment of the present invention.

After the activated mode of the NFC performing part 200 is maintained for a preset constant time, in the case in which a predetermined time elapses, the NFC performing part 200 may be automatically deactivated, and the battery part 300 may be activated, that is, the wireless charging may be performed by transferring the signal to the second switch 500 (S530).

In addition, once the charging is completed by the wireless charging, all functions may be initialized.

That is, in other words, the NFC performing part 200 is activated and the battery part 300 is deactivated.

In this case, the NFC performing part 200 is connected to the first switch 400 of the NFC signal judgment module 100 and transfers the signal from the signal judgment device 133 of the NFC signal judgment module 100 to the first switch 400, thereby making it possible to perform the near field communication, and

the battery part 300 is also connected to the second switch 500 of the NFC signal judgment module 100 and transfers the signal from the signal judgment device 133 of the NFC signal judgment module 100 to the second switch 500, thereby making it possible to wirelessly charge the portable device.

Further, the battery part 300 may be configured to include a battery protecting part (not shown) and a battery cell (not shown). The battery protecting part is provided to protect the battery cell, because there are risks such as overcharging and an overcurrent or a short circuit in the case in which the current directly flows in battery cell without a separate protection circuit when the wireless charging is performed.

That is, in other words, the portable device using the common antenna for both near field communication and wireless charging according to the embodiment of the present invention may transfer the wireless signal applied to the common antenna part 10 to the NFC signal judgment module 100, and the NFC signal judgment module 100 may judge the applied signal to thereby activate the operation of the NFC performing part 200 or the battery part 300 depending on the judged results.

Subsequently, since the portable device using the common antenna for both near field communication and wireless charging according to the embodiment of the present invention may reduce the number of antennas by using one common antenna without using the respective separate antennas as the antenna transmitting and receiving the wireless signal to use both near field communication and wireless charging, and may simplify a configuration of a circuit and reduce an area of the circuit by using one dedicated chip for both near field communication and wireless charging, that is, the NFC signal judgment module without using a separate electromotive circuit for charging for using both near field communication and wireless charging, the portable device may be miniaturized, thinned, and lightened.

As described above, although the present invention has been described with reference to the embodiments and the accompanying drawings, it would be appreciated by those skilled in the art that the present invention is not limited thereto but various modifications and alterations might be made without departing from the scope defined in the claims and their equivalents.

DETAILED DESCRIPTION OF MAIN ELEMENTS

| | |
|---|---|
| 10: | common antenna part |
| 100: | NFC signal judgment module |
| 110: | signal matching part |
| 111: | NFC signal matcher |
| 112: | wireless charging signal |
| 113: | selection switch |
| 120: | signal converting part |
| 121: | RF/DC converter |
| 122: | regulator |
| 130: | signal controlling part |
| 131: | signal demodulator |
| 132: | ID storage part |
| 133: | signal judgment device |
| 200: | NFC performing part |
| 300: | battery part |
| 400: | first switch |
| 500: | second switch |

matcher

1. A portable device using a common antenna for both near field communication (NFC) and wireless charging, the portable device comprising:
a common antenna part transmitting and receiving near field communication and wireless charging signals;
an NFC signal judgment module connected to the common antenna part and sensing a signal applied from the common antenna part or a Tx signal generated from an NFC performing part to thereby judge whether or not the signal applied from the common antenna part or the Tx signal is a near field communication signal;
the NFC performing part connected to the NFC signal judgment module and performing near field communication according to a control signal transferred from the NFC signal judgment module; and
a battery part connected to the NFC signal judgment module and being wirelessly charged according to the control signal transferred from the NFC signal judgment module.

2. The portable device of claim 1, wherein the NFC signal judgment module includes:
a signal matching part converting antenna impedance transferred through the common antenna part into an impedance which is suitable for both near field communication and wireless charging and transferring a sensed near field communication signal to the NFC performing part or a signal controlling part;
a signal converting part including a RF/DC converter converting a wireless signal transferred from the signal matching part into a direct current voltage and a regulator uniformly supplying the direct current voltage converted by the RF/DC converter;
the signal controlling part judging whether or not a signal transferred thereto is a near field communication signal;
a first switch controlling an operation of the NFC performing part depending on a signal of the signal controlling part; and
a second switch controlling an operation of the battery part depending on the signal of the signal controlling part.

3. The portable device of claim 2, wherein the signal matching part includes:
an NFC signal matcher converting the antenna impedance transferred from the common antenna part into the impedance which is suitable for near field communication and transferring a near field communication signal to the NFC performing part;
a wireless charging signal matcher converting the antenna impedance transferred from the common antenna part into the impedance which is suitable for the wireless charging; and
a selection switch transferring a near field communication signal transferred from the NFC signal matcher or a wireless charging signal transferred from the wireless charging signal matcher to the signal converting part.

4. The portable device of claim 3, wherein the selection switch transfers the signal to a selected one of the NFC signal matcher or the wireless charging signal matcher depending on a signal transferred from the signal controlling part.

5. The portable device of claim 2, wherein the regulator supplies the direct current voltage transferred from the RF/DC converter to the battery part through the signal controlling part or the second switch.

6. The portable device of claim 2, wherein the signal controlling part includes:
a signal demodulator demodulating a wireless signal transferred from the signal matching part to obtain digital information;
an identification (ID) storage part storing a unique ID for near field communication; and
a signal judgment device comparing the demodulated signal transferred from the signal demodulator with the unique ID stored in the ID storage part or sensing the Tx signal by the near field communication transferred from the NFC performing part to thereby judge whether or not the demodulated signal or the Tx signal is a near field communication signal.
